(19) United States
(12) Patent Application Publication
(10) Pub. No.: US 2015/0114334 A1
(43) Pub. Date: Apr. 30, 2015

(54) SPARK PLUG FOR INTERNAL COMBUSTION ENGINES INCORPORATING A DIODE

(71) Applicant: Luiz Philippe De Orleans E Bragança, Sao Paulo (KR)

(72) Inventor: Luiz Philippe De Orleans E Bragança, Sao Paulo (KR)

(21) Appl. No.: 14/398,964

(22) PCT Filed: Nov. 21, 2012
(86) PCT No.: PCT/BR2012/000465

§ 371 Date: Nov. 4, 2014

(30) Foreign Application Priority Data
May 4, 2012 (BR) BR2020120105719

(51) Int. Cl. H01T 13/34; F02P 15/00

(52) U.S. Cl. CPC H01T 13/34; F02P 15/00
USPC 123/169 P

(57) ABSTRACT

This patent application of Utility Model refers to a spark plug of the type that has a diode positioned between two portions of the core (3), being said diode (2) disposed internally to the ceramic body (4) of the spark plug (1); the diode (2) acts with the purpose of improving the conduction of the electric current that crosses the spark plug and reaches its electrode (9); said spark plug (1) differs from the spark plugs that belong to the state of the art due to the fact that the unit diode (2) is mounted between two conical concave connectors (A) and (B), of which one has a spring (M) incorporated, thus enabling the mounting of diodes (2) of different diameters and lengths; the use of a tubular spacer (E) is optionally provided to enable the use of diodes (2) of different diameters on such way that the diode (2) is kept correctly positioned, centered within the hole of the ceramic insulator (4); this patent application of Utility Model further provides a diode (2′) having two contact ends (C) where at least one of it is shaped as a spring (M′).

This Patent Application of Utility Model relates to a new method for coupling and positioning diodes within a spark plug for internal combustion engines.

As it is known, the diode positively influences on the generation of the spark used to ignite the air/fuel mixture that is burned by the engine. The basic structure of the referred spark plug is already part of the state of the art, according to the patent application PI-1103943-4 filed in Sep. 13, 2011, by the same holder of this application.

The spark plug herein mentioned is already different from other ordinary spark plugs, due to the fact that it includes, internally in its structure, a diode that has the function of improving the conditions of energy transmission that crosses the body of the spark plug, since its connector (which is the terminal connected to the spark plug wire) until its central electrode (which is the extreme opposite that is kept inserted on the inner part of the combustion chamber), however, continuing researches and imbued of the intention of continuous improvement of its previous patent, the inventor presents this application where the proposed differences and innovations consist on the fact that said diode, in this utility model, is fixed and connected to the terminal and to the core of the main electrode by two conical contacts, equipped with centralizing hole, one of the conical contacts has a spring incorporated.

It is further provided the use of a tubular spacer, to enable the use of diodes in different diameters and lengths, in such way that the diodes are correctly positioned within the hole of the ceramic insulator.

Thus, the proposed patent application of Utility Model provides and enables the installation, within the spark plug, of diodes in different lengths and diameters, featuring different electric characteristics and constructive processes, which enable the manufacturing of spark plugs with different characteristics and also the use of diodes with equal characteristics, but with some dimensional variation.

### STATE OF THE ART

Spark plugs are electric components that are connected to the source of electric pulse through a flexible cable that presents, in its end, a terminal (glow plug) that can be connected to the spark plug terminal itself.

The extreme opposite of the spark plug comprises a terminal equipped with external thread, which can be mounted in an opening similarly equipped with thread that is provided on the engine block, in direct relation with the cylinder, this terminal is threaded on the end where the electrode that generates the spark is incorporated, always when the spark plug is electrically supplied by the source of electric pulse.

Generally speaking, the functional characteristics of the spark plugs are determined by questions related, basically, to the type of material used and to the gap and design of the electrode that is incorporated to the very same.

Still regarding the state of the art, it is known an art whereby a spark plug wire is equipped with a diode that has the function of improving the conditions of the electric current that is provided to the spark plug, thus resulting in a better performance of the very same and, consequentially, improving the performance characteristics of the engine that are directly connected with the efficiency in which the air/fuel mixture burn occurs.

This art of mounting a diode on the spark plug wire comprises the employ of rubber connectors, which aims to protect the electric contact points between the connector and the cable itself, being this type of connector also used to protect the linking area between the cable the terminal of the spark plug.

Regardless of the effective level of performance improvement verified with the use of the diode, the type of mounting commonly used to incorporate such component presents the drawback of enabling the occurrence of points or regions where the phenomenon of current leakage occurs, such phenomenon that must be completely prevented not only by the simple issue of losing efficiency with respect to the level of energy that is sent to the spark plug, but also by the fact that it might represent a possibility of risk of accident if the cable with such damage is handled while the engine is in operation.

In view of the facts presented, the inventor also developed a range of solutions that aims to provide efficient means of having an unity of diode along the energy supply circuit that reaches the spark plug, being such solutions specifically treated on patent applications: PI 1003129-4 “PROCESSO DE MONTAGEM DE DIODO EM CABO DE ALIMENTA [symbol] ÃO DE UM MOTOR DE COMBUSTÃO INTERNA [PROCESS OF MOUNTING DIODES IN SUPPLY CABLE OF AN INTERNAL COMBUSTION ENGINE]”, filed in Aug. 26, 2010; “CONECTOR PARA CABO DE VELA SUPRESSIVO E PROCESSO DE FABRICA [symbol] ÃO DE CONECTOR PARA CABO DE VELA SUPRESSIVO [CONNECTOR FOR SUPPRESSIVE SPARK PLUG WIRE AND PROCESS FOR MANUFACTURING CONNECTOR FOR SUPPRESSIVE SPARK PLUG WIRE], filed in Dec. 15, 2010—without number yet;

“CONECTOR PARA CABO DE VELA SUPRESSIVO [CONNECTOR FOR SUPPRESSIVE SPARK PLUG WIRE]”, filed in Dec. 15, 2010—without number yet; and “CACHIMBO PARA CONEXÃO DE VELA DE IGNI [symbol] ÃO PARA MOTORES DE COMBUSTÃO INTERNA [GLOW PLUG FOR CONNECTION OF SPARK PLUG FOR INTERNAL COMBUSTION ENGINES]”, filed in May 6, 2011—without number yet.

Generally, the patent applications mentioned above present a better performance than previous solutions that belong to the respective state of the art of each case, such fact that haven't reduced the desire of this inventor to search for other solutions equally innovative.

The solutions previously developed relate to the incorporation of a unit of diode in a spark plug wire, in a glow plug, and also the incorporation of a unit of diode on the internal structure of a spark plug.

### OBJECTIVES

The inventor, based on the product belonging to the state of the art, of his own authorship, which already presented a range of advantages when compared to the ordinary spark plugs, among which can be referred the fact that, by counting internally with an unit of diode, the spark plug itself started to count on an own increment in respect to the performance improvement obtained on the air/fuel mixture burn. Said spark plug presented the unit of diode connected directly to the internal circuit of the spark plug, being positioned to said unit of diode in a point located between the connector that receives the corresponding spark plug wire and the electrode that is the region where the spark generation occurs, however, when continuing its researches, to obtain new characteristics to the spark plug.

This patent application of Utility Model provides the mounting of diodes of different diameters, lengths, manufacturing process and materials used for confection of the very same, according to the electric characteristics required for each spark plug. This way, to make each type of spark plug manufactured perform the connection between the diode, spark plug terminal and electrode core, two contacts are used: a conical concave contact “A” on the portion of the terminal of the spark plug that is inserted on the hole of the thermal insulator; and a conical concave contact “B” with an incorporated spring, which provides the contact between the diode and the core of the main electrode. Said conical concave contact “B”, as result of spring effect, keeps the diode pressed between both conical concave contacts “A” and “B”, ensuring the efficiency of the electrical contact and enabling the mounting of diodes with different lengths. It also enables an efficient mounting, even if there is a slight difference on length, resulting of the manufacturing process of the diode.

It is also provided, in this patent application of Utility Model, the occurrence of dimensional variation on the manufacturing of diodes of a same model, which is compensated by the use of the incorporated spring on the connector “B”.

This patent application of Utility Model further provides a tubular spacer to be optionally used to compensate the diameter difference between diodes of characteristics, models and/or processes of different manufacturing, thus ensuring its centered position with respect to the hole of the thermal insulator.

It is provided a variant, of which the function of the connector with spring is present in at least one of the ends of the diode, which is shaped as a spring and presents a contact end as well. This way, the diode itself starts to have the duties of contact and spring.

With this, some advantages are obtained, even comparing it with the spark plug previously proposed by the same inventor, because this patent application of Utility Model enables the confection of spark plugs with different electric and functional characteristics, due to the use of different types and dimensions of diodes without the need of alteration of the dimensional characteristics of all the other component parts of the spark plug, thus optimizing the manufacturing and reducing the manufacturing cost.

The spark plug, object of this invention patent application, can be manufactured according to the totality of models (and specifications) commonly provided for the wide range of internal combustion engines currently in use.

### DESCRIPTION OF THE DRAWINGS

To complement this description in order to obtain a better understanding of the characteristics of this patent application of Utility Model, and according to a preferred practical embodiment of the same, it is enclosed to the description a set of figures, where on an exemplified but not limiting way the following is represented:

FIG. 1 illustrates a front cross-section view of the proposed spark plug;

FIG. 2 illustrates a zoomed view of the “X” detail indicated in FIG. 1; and

FIG. 3 illustrates a front view of the variant of which the diode has, at least, one of its ends configured as a spring.

According to the illustrated on the figures above described, this patent application of Utility Model, “SPARK PLUGS FOR INTERNAL COMBUSTION ENGINES INCORPORATING A DIODE”, relates to a spark plug for internal combustion engines, generally indicated by the numeric reference 1.

The general configuration of the spark plug 1 was not substantially changed, since that the same is equipped with its traditional core 3, which crosses its ceramic body 4, which acts as an insulator, whereas around the bottom portion 5 of the referred ceramic body 4 is provided the hexagonal terminal 6 that has a head 7 equipped with thread 8, of which the electrode 9 is projected.

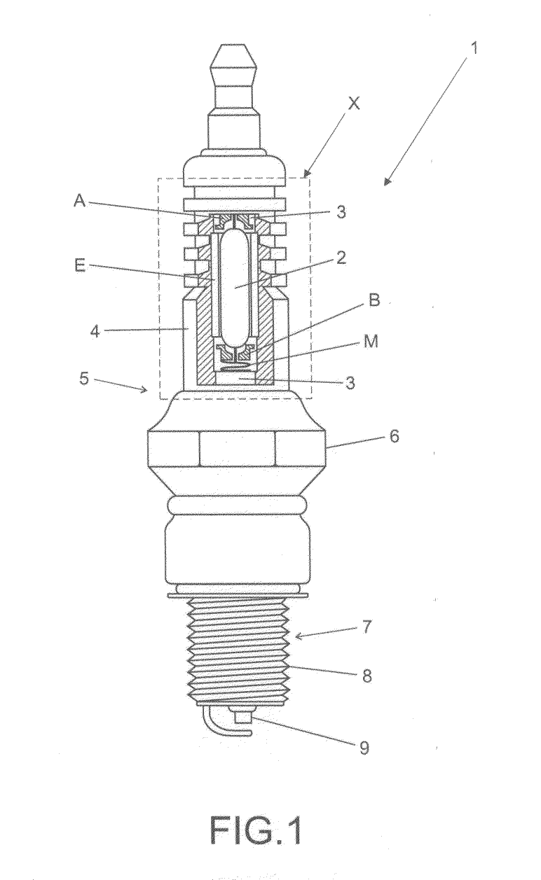

The aforementioned FIG. 1 enables to determine the fact that the diode 2 (pictured on a schematic manner) is mounted between two conical concave contacts, a conical concave contact “A” on the portion of the terminal of the spark plug that is inserted on the hole of the thermal insulator; and a conical concave contact “B” with an incorporated spring M around it, which provides the contact between the diode and the core of the main electrode. The said conical concave contact “B”, as result of the compression effect performed by the spring M, keeps the diode 2 pressed between both conical concave contacts “A” and “B”, ensuring the efficiency of the electrical contact and enabling the mounting of diodes with different lengths. It also enables an efficient mounting, even if there is a slight difference on length, resulting of the manufacturing process of the diode. The conical concave contacts and the diodes are between the two portions of the core 3, being disposed, by consequence, internally to the ceramic body 4 of the spark plug 1.

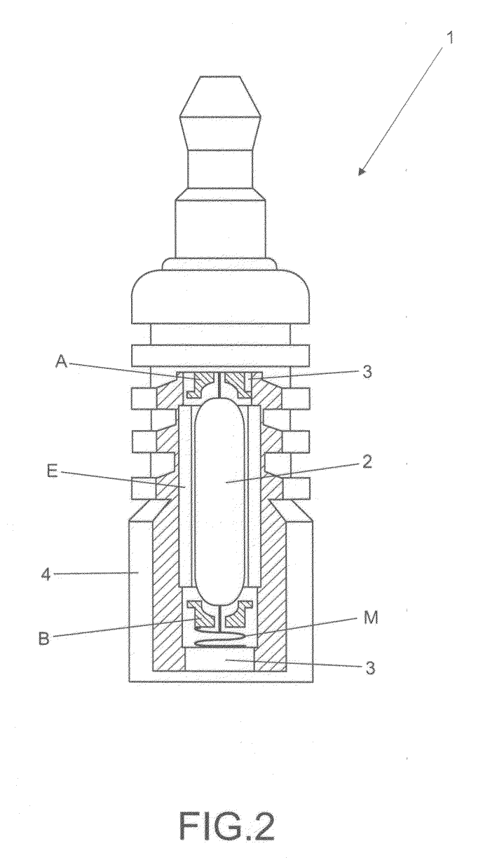

FIG. 2, which is an amplified detail taken from the FIG. 1, such as indicated by the arrow X, allows to accurately visualize, on a schematic manner, the electrode, the conical concave contact “A”, the diode 2, the conical concave contact “B”, the spring M incorporated to the very same, the main electrode and the tubular spacer E within where the diode 2 is.

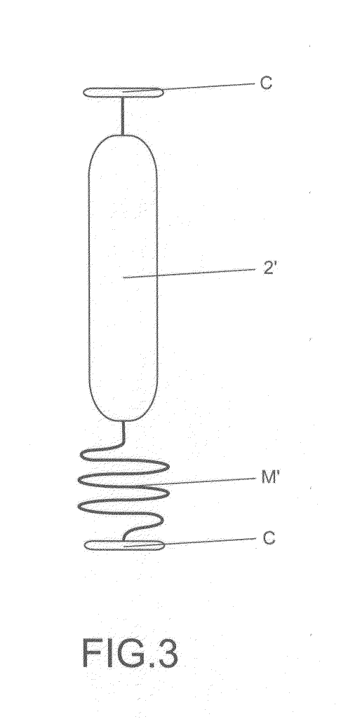

FIG. 3 presents a variant where the function of the connector with spring is incorporated in at least one of the ends of the diode 2′, shaped such as a M′ spring with contact end C accurately seen, being such contact C present on the opposite end of the diode 2′ as well.

1. “SPARK PLUG FOR INTERNAL COMBUSTION ENGINES INCORPORATING A DIODE”, of the type used to promote the burn of the air/fuel mixture in internal combustion engines, which is indicated by the numerical reference (1) and comprises a core (3), which crosses its ceramic body (4), wherein around the bottom portion (5) of the aforementioned ceramic body (4) is provided the hexagonal terminal (6) that has a head (7) equipped with thread (8), of which the electrode is projected (9); the spark plug (1) has a unit of diode (2) mounted between two portions of the core (3), being said diode (2) disposed internally to the ceramic body (4) of the spark plug (1), which is characterized in that the diode (2) is installed between two conical concave contacts (A) on the portion of the spark plug (1) terminal inserted in the hole of the thermal insulator; and a conical concave contact (B) with spring (M) incorporated.

2. “SPARK PLUGS FOR INTERNAL COMBUSTION ENGINES INCORPORATING A DIODE” according to the claim 1, wherein a tubular spacer (E) is provided within which the diode is mounted (2).

3. “SPARK PLUGS FOR INTERNAL COMBUSTION ENGINES INCORPORATING A DIODE” according to the claim 1, wherein a diode (2′) is provided, which has two contact ends (C) where at least one of them is shaped as a spring (M′).
